(19) United States
(12) Patent Application Publication
(10) Pub. No.: US 2025/0371473 A1
(43) Pub. Date: Dec. 4, 2025

(54) SYSTEMS AND METHODS FOR MANAGING ONE OR MORE PROJECTS

(71) Applicant: Engineer.ai Corp., Salt Lake City, UT (US)

(72) Inventors: Sachin Dev Duggal, Salt Lake City, UT (US); Priyanka Kochhar, London (GB); Rohan Patel, London (GB); Yash Mittal, Delhi (IN); Lalit Kumar Maurya, Delhi (IN)

(73) Assignee: Engineer.ai Corp., Salt Lake City, UT (US)

(21) Appl. No.: 18/679,458

(22) Filed: May 31, 2024

(51) Int. Cl. G06Q 10/0637

(52) U.S. Cl. CPC G06Q 10/0637

(57) ABSTRACT

Systems and methods for managing one or more projects. The system includes a processor coupled to a memory. The processor is configured to receive a request for completing one or more projects. The request includes one or more features assigned for each project. The processor is further configured to communicate to one or more developers that are selected by the processor, a project workflow to complete the one or more projects. The project workflow is generated based on an optimization, by the processor, of one or more parameters for timely completing the projects. The processor is further configured to determine an average time interval taken to complete each project. In addition, the processor is configured to update the project workflow based on the average time interval determined.

### FIELD

This disclosure relates to project management, and more particularly to systems and methods for estimating a possibility that one or more projects are likely to be delayed.

### BACKGROUND

Project management refers to leading an entity to achieve project goals within specific deadlines. Tracking the progress of projects is a challenging task as multiple factors such as pending work, time taken, number of employees, cost estimates, and the like are continuously monitored. It is also essential that projects are delivered to the respective clients promptly. Tracking the progress of projects and any delays may require a manager to monitor the project status continuously. However, in the case of complex and lengthy projects having multiple stages and set across various locations, multiple managers would be expected to monitor the status, progress, and any disruptions during the progress lifecycle. Thus, there is a need in the art for a more efficient way to track the status of multiple projects to ensure that they are completed on time.

### SUMMARY

The disclosed subject matter relates to a system for estimating a project delay. The system includes a processor coupled to a memory. The processor is configured to receive a request for completing one or more projects. The request includes one or more features assigned to each project. The processor is further configured to divide the one or more projects into one or more tasks. The one or more tasks include one or more actors that contribute to each project. The processor is further configured to determine a completion percentage for each task. The completion percentage is determined based on one or more parameters associated with each actor. In addition, the processor is configured to determine a probability that the one or more projects will be delayed based on the completion percentage determined for each task.

The disclosed subject matter also relates to a method for estimating a project delay. The method includes receiving a request for completing one or more projects. The request includes one or more features assigned to each project. The method further includes dividing the one or more projects into one or more tasks. The one or more tasks include one or more actors that contribute to each project. The method further includes determining a completion percentage for each task. The completion percentage is determined based on one or more parameters associated with each actor. In addition, the method includes determining a probability that the one or more projects will be delayed based on the completion percentage determined for each task.

The disclosed subject matter also relates to a computer readable storage medium having data stored therein representing software executable by a computer, the software comprising instructions that, when executed, cause the computer readable storage medium to perform receiving a request for completing one or more projects. The request includes one or more features assigned to each project. The instructions further cause the computer readable storage medium to perform dividing the one or more projects into one or more tasks. The one or more tasks include one or more actors that contribute to each project. The instructions further cause the computer readable storage medium to perform determining a completion percentage for each task. The completion percentage is determined based on one or more parameters associated with each actor. In addition, the instructions cause the computer readable storage medium to perform determining a probability that the one or more projects will be delayed based on the completion percentage determined for each task.

The disclosed subject matter further relates to a system for managing one or more projects. The system includes a processor coupled to a memory. The processor is configured to receive a request for completing one or more projects. The request includes one or more features assigned for each project. The processor is further configured to communicate to one or more developers that are selected by the processor, a project workflow to complete the one or more projects. The project workflow is generated based on an optimization, by the processor, of one or more parameters for timely completing the projects. The processor is further configured to determine an average time interval taken to complete each project. In addition, the processor is configured to update the project workflow based on the average time interval determined.

The disclosed subject matter also relates to a method for managing one or more projects. The method includes receiving a request for completing one or more projects. The request includes one or more features assigned for each project. The method further includes communicating to one or more developers that are selected, a project workflow to complete the one or more projects. The project workflow is generated based on an optimization of one or more parameters for timely completing the projects. The method further includes determining an average time interval taken to complete each project. In addition, the method includes updating the project workflow based on the average time interval determined.

The disclosed subject matter also relates to a computer readable storage medium having data stored therein representing software executable by a computer, the software comprising instructions that, when executed, cause the computer readable storage medium to perform receiving a request for completing one or more projects. The request includes one or more features assigned for each project. The instructions further cause the computer readable storage medium to perform communicating to one or more developers that are selected, a project workflow to complete the one or more projects. The project workflow is generated based on an optimization of one or more parameters for timely completing the projects. The instructions further cause the computer readable storage medium to perform determining an average time interval taken to complete each project. In addition, the instructions cause the computer readable storage medium to perform updating the project workflow based on the average time interval determined.

In addition, the disclosed subject matter relates to a system for evaluating one or more projects. The system includes a processor coupled to a memory. The processor is configured to select one or more developers to complete the one or more projects based on one or more selection parameters. The processor is further configured to communicate to the one or more developers that are selected by the processor, a project workflow to complete the one or more projects. The project workflow is generated based on an optimization, by the processor, of one or more parameters for timely completing the projects. In addition, the processor is further configured to determine a release feedback of each project based on one or more parameters.

The disclosed subject matter also relates to a method for evaluating one or more projects. The method includes selecting one or more developers to complete the one or more projects based on one or more selection parameters. The method further includes communicating to the one or more developers that are selected, a project workflow to complete the one or more projects. The project workflow is generated based on an optimization of one or more parameters for timely completing the projects. In addition, the method further includes determining a release feedback of each project based on one or more parameters.

The disclosed subject matter also relates to a computer readable storage medium having data stored therein representing software executable by a computer, the software comprising instructions that, when executed, cause the computer readable storage medium to perform selecting one or more developers to complete the one or more projects based on one or more selection parameters. The instructions further cause the computer readable storage medium to perform communicating to the one or more developers that are selected, a project workflow to complete the one or more projects. The project workflow is generated based on an optimization of one or more parameters for timely completing the projects. In addition, the instructions cause the computer readable storage medium to perform determining a release feedback of each project based on one or more parameters.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a project management system in an embodiment of the disclosed subject matter.

FIG. 7 is a schematic illustrating an exploded view of the server of the project management system of FIG. 6 in an embodiment of the disclosed subject matter.

FIG. 8 is a schematic illustrating a view displaying a division of the one or more projects amongst one or more actors that contribute to each project in an embodiment of the disclosed subject matter.

FIG. 9 is a schematic illustrating a view displaying a bar graph depicting customer satisfaction for the one or more projects in an embodiment of the disclosed subject matter.

FIG. 10 is a schematic illustrating a view displaying a line graph depicting customer satisfaction for the one or more projects in an embodiment of the disclosed subject matter.

FIG. 11 is a flow diagram illustrating a method for estimating a project delay in an embodiment of the disclosed subject matter.

FIG. 12 is a flow diagram illustrating a method for managing one or more projects in an embodiment of the disclosed subject matter.

FIG. 13 is a flow diagram illustrating a method for providing recommendations to the one or more developers based on their average time interval in an embodiment of the disclosed subject matter.

FIG. 14 is a flow diagram illustrating a method for evaluating one or more developers in an embodiment of the disclosed subject matter.

FIG. 15 is a flow diagram illustrating a method for determining actions for the one or more developers based on the release feedback in an embodiment of the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, well-known apparatus structures, and well-known techniques are not described in detail.

The terminology used, in the present disclosure, is for the purpose of explaining a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

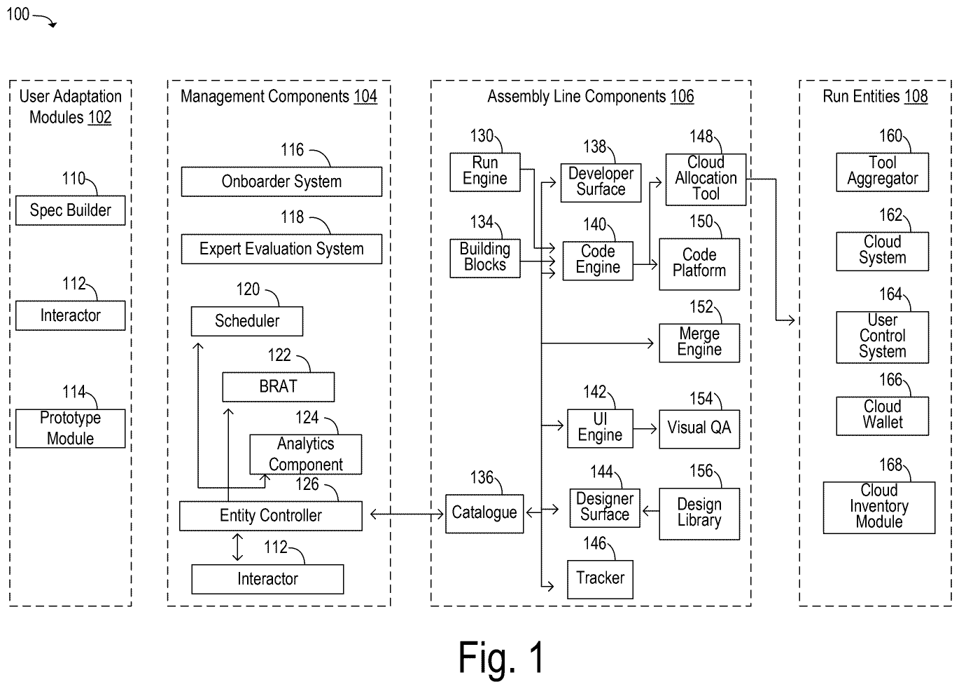

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Spec builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

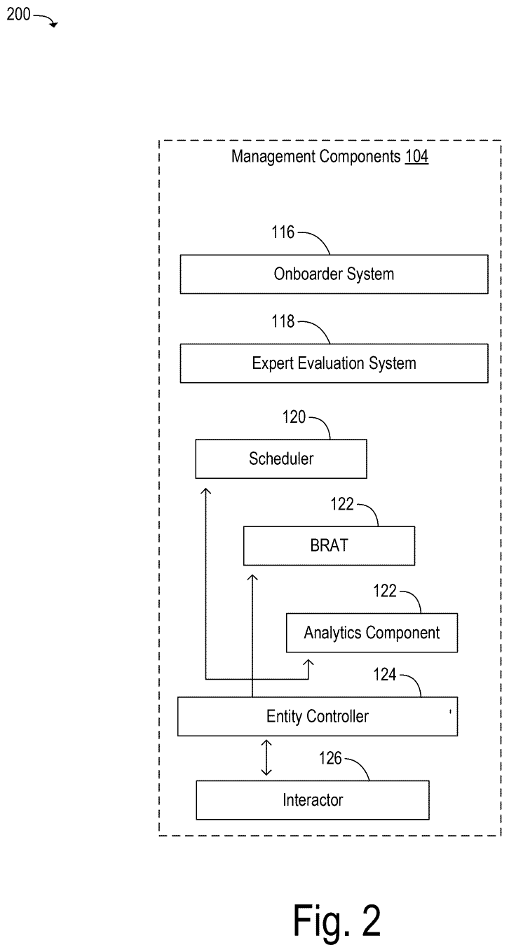

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

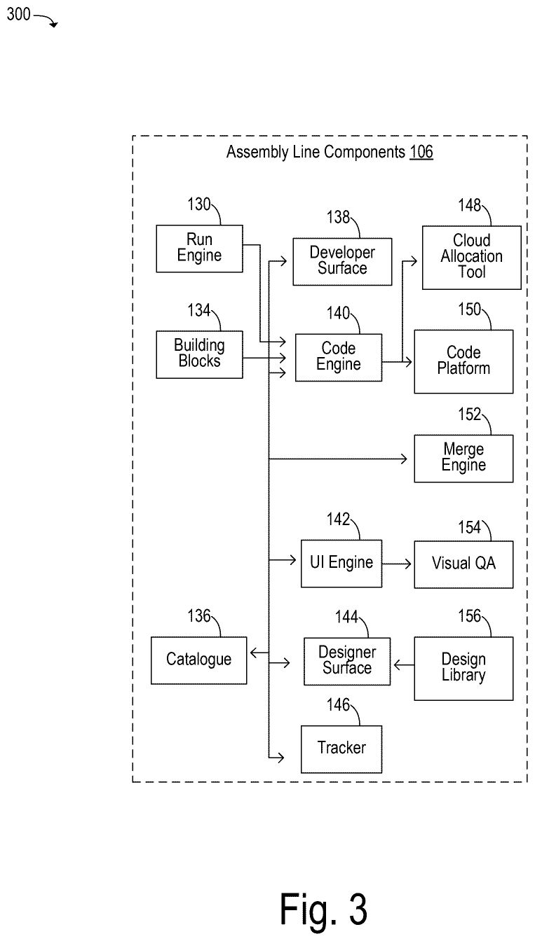

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

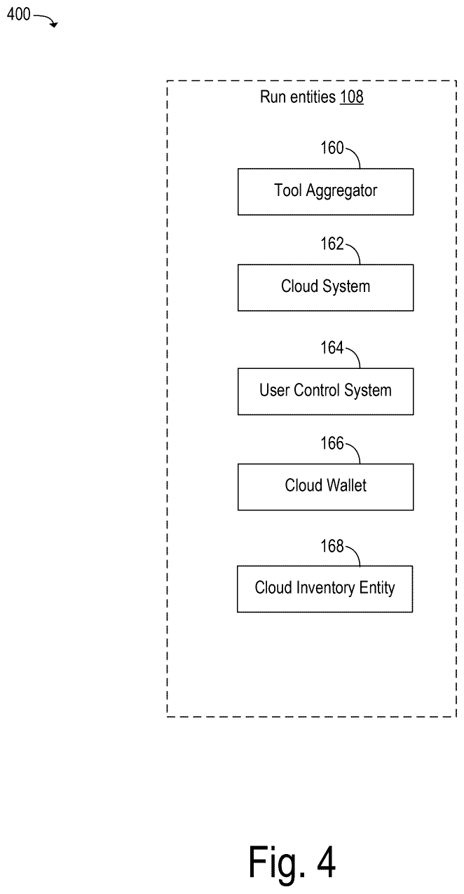

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

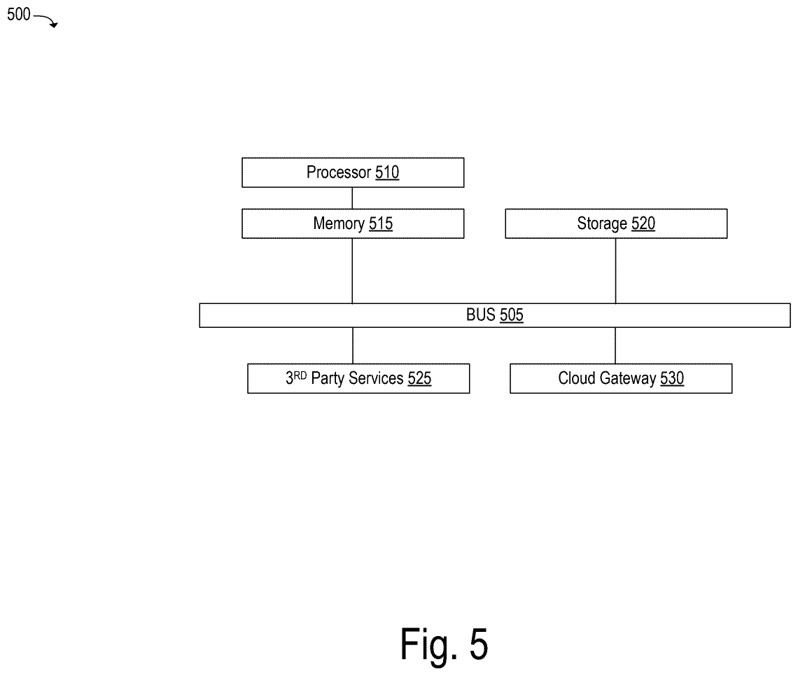

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, one or more processors 510 connected to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3^{rd} party services such as Office 365 and Adobe. Similarly, users may access the computing system 500 via a cloud gateway 530. For instance, a user on a separate computing system may connect to the computing system 500 to access data, interact with the run entities 108, and even use 3^{rd} party services 525 via the cloud gateway.

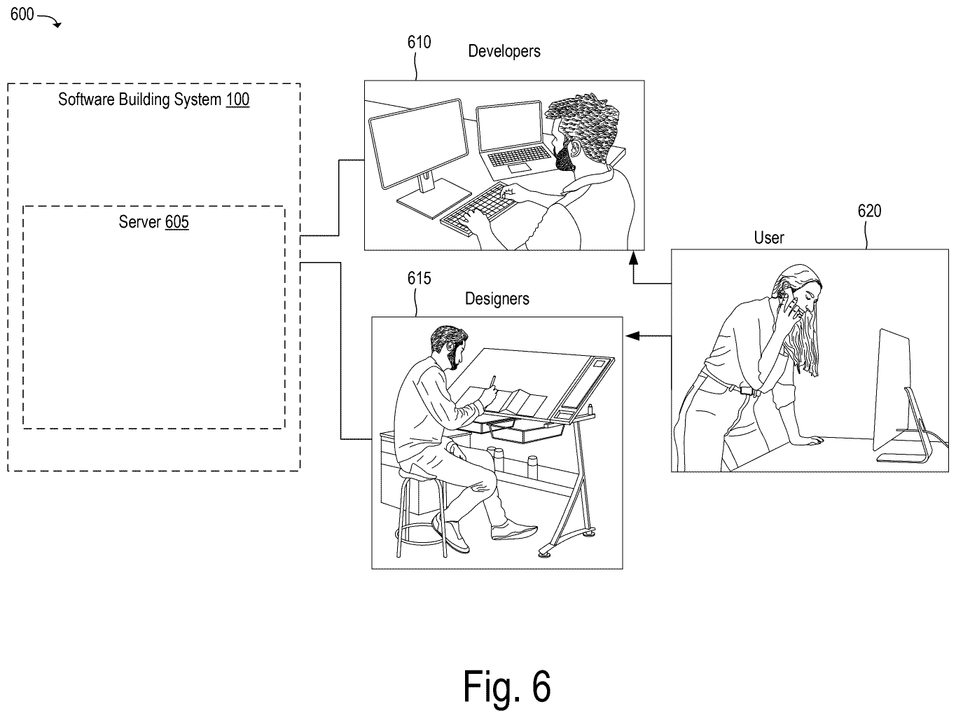

Referring to FIG. 6, FIG. 6 is a schematic diagram of a project management system 600 in an embodiment of the disclosed subject matter. In an exemplary embodiment, the project management system 600 comprises the software building system 100, one or more users 620, one or more developers 610, and one or more designers 615. In the embodiment shown for the project management system 600, the software building system 100 comprises a server 605. The server 605 may be a computing system 500.

In the exemplary embodiment shown in FIG. 6, the server 605 is in communication with one or more users 620, one or more developers 610, and one or more designers 615. Various embodiments may include additional personnel or computing resources that produce code, content, or the like for the software application. For example, the server 605 may be in communication with one or more quality assurance engineers to assemble, test, and package the software application.

In an exemplary embodiment, the server 605 may transfer allocating units to the users 620. The users 620, as used herein, may be referred to an individual person, small business owner/manager, large business owner/manager, hotel manager, restaurant manager, and the like. The users 620 may distribute the allocating units to various personnel, computing resources, or other services to work on the software application. In an exemplary embodiment, allocating units may be referred to as tokens, points, or the like. As used herein, the allocating units are commonly referred to as points.

In an exemplary embodiment, the users 620 may distribute points to developers 610 and designers 615. The developers 610, as used herein, may be referred to as experts, developer experts, coders, software engineers, engineers, and the like. In various embodiments, a list of developers 610 may be supplied by an onboarding system 116. In various embodiments, the users 620 contact and selects their developers 610.

In an exemplary embodiment, the BRAT 122 may determine a list of developers 610 for a software project. In one implementation, the BRAT 122 may determine multiple lists of developers 610 for the users 620 based on multiple qualities of a software application and/or multiple software application visions. For instance, the BRAT 122 may determine a list of developers for a small-size software application, a medium-sized software application, and a large medium-sized software application. In another instance, the BRAT 122 may determine a list of developers for a consumer-based software application and an industry-based software application where a consumer-based software application has a focus on large volume consumer communication and an industry-based software application has a focus on intimate communication with a small number of industries.

The designers 615, as used herein, may be referred to as artists, web designers, and the like. The designers 615 may have different skill levels and different skill areas. In an exemplary embodiment, the BRAT 122 may provide a list of designers 615 along with their talent set. A user may use the provided information on designers to allocate resources to designers 615 in a way that promotes the users 620 vision of the software application.

The project management system 600 allows the users 620 freedom to distribute points according to their vision and limited resources for the software application project. Accordingly, the tracking system 600 maximizes creativity at a high level by allowing the users 620 strategic control over high-level management decisions in the software project. The users 620 is not limited to arbitrary or abstract criteria for selecting developers or designers or how to allocate points to developers or designers. Even where the cloud allocation tool 148 determines a number of points for the users 620, the tracking system 600 provides for the users 620 to distribute those points without limitations.

The distribution of points from the users 620 to developers 610, designers 615, or the like is a signal to the developers 610 and designers 615 to provide an amount of work commensurate with the number of points transferred. The server 605 may provide lower management level decisions to the developers 610, designers 615, or other personnel or computing resources based on the points allocated to them by the users 620. In an exemplary embodiment, the server 605 may provide payment to the developers 610 and designers 615 based on the points distributed to them.

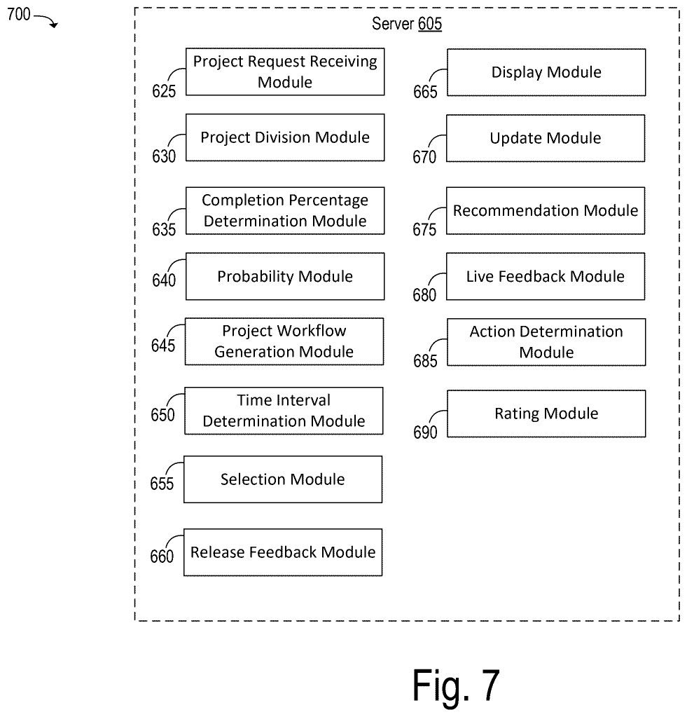

Referring to FIG. 7, FIG. 7 illustrates an exploded view 700 of the server 605 of the project management system 600 of FIG. 6 in an embodiment of the disclosed subject matter. As shown, the server 605 includes a project request receiving module 625, a project division module 630, a completion percentage determination module 635, a probability module 640, a project workflow generation module 645, a time interval determination module 650, a selection module 655, a release feedback module 660, a display module 665, an update module 670, a recommendation module 675, a live feedback module 680, an action determination module 685, and a rating module 690. The functionality of each module is explained in further detail below.

In an exemplary embodiment, the project request receiving module 625 is configured to receive a request for completing one or more projects. The request may include one or more features assigned for each project, a project timeframe, and one or more building blocks that implement the one or more features. The one or more features may include a login screen, dashboard, login page, and the like. The users 620 may login via the login page by providing their email address, password, and other credentials useful for verifying their correct identity.

The project timeframe corresponds to a visual list of one or more tasks, activities, and schedules depicting a plan for completing each project. The project timeframe may be represented in a graphical or tabular manner. Further, the one or more building blocks are reusable pieces of code that implement functionalities of the one or more features assigned for each project. For example, the code may be written using C language, C++, Java, Phyton, or any appropriate programming language that is known to a person skilled in the art.

In an exemplary embodiment, the project division module 630 divides the one or more projects into one or more tasks. The one or more tasks include one or more actors that contribute to each project. In an example, the one or more actors may include a client, productologist, expert, ninja, and sensei. The client may refer to a person, a group/entity, or the one or more users 620 (as explained in FIG. 6) that initiate the one or more projects for completion. The one or more developers 610 and the one or more designers 615 communicate their work products to the client, who then reviews the same and provides their views/comments. The productologist works as the client's product owner and ensures they understand the client vision as well as providing excellent customer experience. The productologist educates, guides, and advises a product manager of the customer while developing their product(s). Once a build card is finalized, the productologist is responsible for moving it to the right stage so that it can be picked up for design or development.

The expert is responsible for developing various stages of the one or more projects. In an example, the expert may include the one or more developers 610 and the one or more designers 615. The experts are selected based on a certain criteria and must have certain expertise and experience while working on the projects. The experts may be within the organization, outside the organization, or from third parties. Further, the ninja is responsible for hiring the experts from a capacity network and managing their work. The ninjas make sure that the experts release various stages/versions of the projects in time. The ninjas then communicate this tracking information to the client. In addition, the sensei (may also be referred to as technical architect) delivers technical solutions while managing a large team. The large team may include one or more developers 610 and one or more designers 615.

In an exemplary embodiment, the completion percentage determination module 635 determines a completion percentage for each task. The completion percentage is used for indicating a weightage that each task contributes for each project. The completion percentage may be determined based on one or more parameters associated with each actor. For instance, the one or more parameters may be based on at least one of an average time taken to complete each task, a project complexity, a value of the projects, and the like.

The project complexity refers to a difficulty level of the projects. For instance, each project may be grouped into either an easy project, medium project, or tough project. This grouping may be provided by the users 620 for each project assigned by them to the developers 610 and the designers 615. The value of the project corresponds to a value that each project holds to the project managers, stakeholders, clients, customers, and the like. The project value may be determined based on factors such as earned value, planned value, project cost, delays in the project, and the like.

Based on the above-mentioned parameters, the completion percentage determination module 635 assigns the percentages for each stage of the one or more projects. The percentage also indicates a weightage amount that each task holds for the project. For example, if the average time taken to complete each task is high, the project complexity is medium/tough, and the project is holding a high value, the completion percentage determination module 635 may assign higher percentages for the stages for such projects. In case of a lesser average time and lower project complexity, the completion percentage determination module 635 may assign lesser percentages for the stages for those kind of projects.

In an exemplary embodiment, the probability module 640 determines a probability that the one or more projects will be delayed. The probability may be determined based on the completion percentage determined for each task by the completion determination percentage module 635. In an example, the probability may be determined using a Bayesian network. A Bayesian network, also known as a Bayes network, belief network, or probabilistic directed acyclic graphical model (PDAG), is a statistical model that represents a set of variables and their probabilistic dependencies in the form of a directed acyclic graph (DAG). It is named after the Reverend Thomas Bayes, who made significant contributions to probability theory.

The nodes in a Bayesian network represent random variables, and the directed edges between nodes represent probabilistic dependencies between the variables. Each node is associated with a conditional probability distribution that quantifies the probability of the variable taking a specific value given the values of its parent variables.

In an example, the project delays using a Bayesian network involves modeling the factors that can impact project timelines and using probabilistic reasoning to estimate the likelihood of delays. First, the variables that may effect project delays are defined. For instance, the variables may include task duration, resource availability, dependencies, risks, external factors, and the like. Once the variables have been defined, a directed acyclic graph (DAG) that represents the dependencies and relationships between these variables may be created. For example, the task duration may depend on resource availability and dependencies, resource availability may depend on external factors, and risks may depend on task duration and resource availability. For each node in the Bayesian network, conditional probability tables (CPTs) that capture the probabilistic relationships between variables are defined. These tables will express the likelihood of certain outcomes given the values of parent nodes.

Furter, evidence may be introduced based on the current project status. For example, if a task takes longer than expected, the Bayesian network is updated with this evidence and the changes are propagated through the network to update probabilities for other related variables. The project status needs to be continuously monitored and the Bayesian network should be updated as new information becomes available. This iterative process helps refine the probability estimates as the project progresses.

Once the Bayesian network has been constructed, initialized, and updated with evidence, it may be used to assess the probability of project delays. The Bayesian network may be used to identify the event or condition that represents a project delay. This may be a specific task taking longer than expected, a resource constraint, or any other factor that contributes to project delays. The Bayesian network may also be used to query the posterior probabilities of the event of interest given the observed evidence. This may be achieved using Bayes' theorem and involves calculating the probability distribution of the event given the current state of the project. The computed probabilities may be evaluated to understand the likelihood of project delays. This information may be presented as a probability distribution or a single probability value, depending on the specific goals of the analysis.

In an exemplary embodiment, the project workflow generation module 645 is configured to generate a project workflow for completing the one or more projects. The project workflow may be generated based on one or more parameters. The one or more parameters assist in timely completing each project. The one or more parameters may include at least one of a finish time path duration, a risk distribution, value of the project, a project speed, and a proximity to a completion deadline. Each parameter is explained in further detail below.

The project workflow generation module 645 uses a path duration algorithm to determine the finish time path duration for each project. The algorithm identifies dependencies between tasks based on a list of tasks and projects received from the project request receiving module 625. It determines if one or more works can be performed parallelly. Once identified, the algorithm determines a path corresponding to the sequence(s) of tasks with the maximum duration. Upon detection of the path, the algorithm then calculates a float or slack. The float refers to a delay amount with which at least one task may be delayed without impacting other tasks and a deadline of each project. The project workflow generation module 645 performs risk distribution activities to minimize project risks, such as operational, financial, and underwriting risks. The project value is determined by factors like earned value, planned value, project cost, and delays. Project speed and proximity to completion deadlines monitor progress, deadlines, issues raised by developers, designers, and users, project managers' targets, and achievements. The project value is a crucial aspect for project managers, stakeholders, clients, and customers.

In an exemplary embodiment, the time interval determination module 650 determines an average time interval taken to complete each project. The average time interval to complete each task is determined by adding the times taken by the one or more developers 610 to complete each task and then dividing this summation by the total number of developers 610. Instead of having the developers 610 manually enter their times, the time interval determination module 650 is capable of tracking the times taken by the one or more developers 610 to complete each task within the activity and then determining the time taken to complete each task by summing the task times. The average time interval is also determined based on a combination of a previous time interval and a current time interval taken by the one or more developers 610 to complete each task of the one or more projects. The previous time interval refers to previous times taken by the one or more developers 610 while working on the tasks and the current time interval refers to current or present times taken by the one or more developers 610 while working on the tasks. The time interval determination module 650 analyzes the previous time and current times of the one or more developers 610 for determining the final/appropriate average time taken. The average time interval(s) determined by the time interval determination module 650 may then be communicated to the project workflow generation module 645. The project workflow generation module 645 may then update the previously generated project workflow. In an example, the updates may include modifying tasks of the projects, onboarding more developers 610 or designers 615 to work on tasks consuming higher times for completion, establishing new project goals/deadlines, and the like.

In an exemplary embodiment, the selection module 655 selects the one or more developers 610 to complete the one or more projects. For instance, the one or more developers 610 may be selected based on one or more selection parameters. In an example, the one or more selection parameters may include a background of the one or more developers, works performed by the one or more developers, and a performance of the one or more developers in an onboarding assessment. The onboarding assessment is an automated test for the one or more developers 610, primarily focusing on programming languages like C++ or Java. The selection module 655 generates questions in these areas. The selection module 655 analyzes the background and work experience of the developers 610, generating an appropriate quiz for them to take. This ensures that the developers 610 are well-prepared for their new role.

In an exemplary embodiment, the release feedback module 660 determines a release feedback for each project. The release feedback may be determined based on one or more parameters. For instance, the one or more parameters may be based on at least one of a customer satisfaction, bug reports, performance metrics, and project delay. Release feedback refers to the feedback or input received after a product or software release. When a company or development team launches a new product, feature, or version of a software application, they often seek feedback from users, customers, or other stakeholders to understand how well the release meets expectations and to identify any issues or areas for improvement.

Release feedback may come in various forms, including user reviews, customer surveys, bug reports, and direct user feedback through support channels or social media. Analyzing release feedback is crucial for developers and product teams to make informed decisions about future updates, enhancements, or bug fixes. It helps them understand user satisfaction, identify any unexpected problems, and gather insights into user needs and preferences.

Customer satisfaction refers to the degree of contentment or fulfillment that a customer experiences with a product, service, or interaction with a company. It is a key indicator of how well a business is meeting the expectations and needs of its customers. Customer satisfaction is subjective and can be influenced by various factors, including the quality of the product or service, the level of customer support, the overall customer experience, and the value for money. Customer satisfaction is a crucial aspect of building and maintaining a successful business, as it directly impacts customer retention and the overall success of a company in the marketplace. Companies that prioritize customer satisfaction are more likely to build strong, long-lasting relationships with their customers, which can contribute to sustained business success.

Bug reports are documents that provide detailed information about issues or problems in software, hardware, or any other system. These reports are typically created by users, testers, or quality assurance professionals who encounter unexpected behavior, errors, or defects in a product. Bug reports are essential for the developers 610 and engineers as they help identify and address issues in the system, improving overall software or product quality. By providing comprehensive bug reports, users and testers help the one or more developers 610 identify and fix issues efficiently, leading to a more stable and reliable product. Effective communication and collaboration between users, testers, and developers are crucial for the successful resolution of bugs.

Performance metrics are measures used to assess the effectiveness, efficiency, or quality of a process, system, or product. In various fields and industries, performance metrics play a crucial role in evaluating and improving performance. These metrics help organizations and individuals track their progress, identify areas for improvement, and make informed decisions. In an example, the performance metrics may include business metrics, financial metrics, operational metrics, customer metrics, employee metrics, healthcare metrics, and the like. The selection of the performance metrics depends on the specific goals and objectives of the entity being measured. In many cases, a combination of metrics is used to provide a comprehensive assessment of performance. Regular monitoring and analysis of these metrics can inform strategic decisions and continuous improvement efforts.

In an exemplary embodiment, the display module 665 displays the probability determined by the probability module 640 using a dashboard. Along, with the probability, the display module 665 may also display the completion percentage determined by the completion percentage determination module 635, the project workflow generated by the project workflow generation module 645, and the customer satisfaction amongst the one or more projects.

In an exemplary embodiment, the update module 670 updates the one or more tasks assigned by the project division module 630 based on the probability determined by the probability module 640. The updates made by the update module 670 are then communicated to the one or more actors assigned to work on the one or more projects. In an example, if the probability of delay is high from the experts end, the update module 670 may update the task such that more developers 610 need to be onboarded for timely completing the projects. In another example, if the probability of delay is high from the ninjas end, the update module 670 may update the task such that the ninjas are required to communicate with the experts in order to timely deliver the projects. For instance, the communication may be sending more periodic reminders, conducting evaluations regularly, scheduling feedback sessions with the experts, and the like. Thus, the update module 670 is capable of updating the tasks based on the current progress of each project. This thus ensures that the projects are duly completed and assistance/modifications are appropriately provided wherever required.

In an exemplary embodiment, the recommendation module 675 provides one or more recommendations to the one or more developers 610. The one or more recommendations may be provided based on the average time interval determined by the time interval determination module 650. For instance, the recommendations provided may be related to improving the output or productivity of the one or more developers 610 while working on the projects. The one or more recommendations may be provided to the one or more developers 610 using at least one of a written message, voice message, email message, QR code, and the like. The written message refers to a communication conveyed through written or printed words. This form of communication can take various formats, such as letters, emails, text messages, notes, memos, reports, and more. The voice message is a form of communication in which spoken words or sounds are recorded and sent to a recipient.

In an exemplary embodiment, the live feedback module 680 receives feedback from the one or more actors based on the one or more tasks that have been updated and receives feedback from the one or more developers 610 based on the one or more recommendations provided by the recommendation module 675. The main purpose of providing the feedback is to develop a better understanding. The feedback provides an opportunity for the one or more developers 610 and the designers 615 to raise their queries and doubts in a suitable manner. The live feedback module 680 further provides live feedback to the one or more developers 610 while working on the one or more projects. The one or more developers 610 may provide their feedback using at least one of a voice message, verbal message, email message, QR code, and the like.

With the click of a button (not shown) on the software application, the one or more developers 610 may provide their voice message, verbal message, and email message. The term “button”, as used herein, may refer to any touch input that, when touched, causes the application to execute a command. Examples of the button include but are not limited to a mechanical button, digital button, capacitive sensing button, inductance sensing button, holographic button, and the like. The person 102 may also choose which message type they would like to use for providing their feedback upon clicking the button. The live feedback module 680 may also instantly reply back to the one or more developers 610 using the message type selected by them.

For voice message, the device associated with the one or more developers 610 or designers 615 includes an in-built speaker and microphone, to which they may speak. Once the one or more developers 610 provides their feedback/query, the input speech is transcribed into text. Keywords are extracted from the transcribed text and trained data may be used to provide a voice answer back to the one or more developers 610.

For verbal messages, a chat box is presented to the one or more developers 610 or designers 615 on their device where they may type in their feedback/query. Here, the live feedback module 680 may function as a chat bot, which is a developed program that can have conversations with people. The chatbot is trained using machine learning (ML) algorithms and is programmed to understand questions and search for the answer in a knowledge database. The chat bot may further learn from its previous and current interactions with people for developing correct answers. Further, the one or more developers 610 may also choose to embed the verbal messages into a QR code, which can be accessible upon scan. For email messages, the one or more developers 610 send their feedback/queries to an assistance email ID of the software application.

In an exemplary embodiment, the action determination module 685 determines one or more actions for the one or more developers 610 to take based on the release feedback determined by the release feedback module 660. Improving release feedback involves a combination of proactive planning, effective communication, and responsiveness to user input. For instance, the one or more actions may include beta testing, introducing feedback channels, user surveys, education, iterative development, and the like.

Beta testing involves releasing a pre-release version of a product to a select group of beta testers before the official public release. This phase allows the one or more developers 610 to gather feedback, identify issues, and make improvements based on real-world usage. Feedback channels refer to the various avenues or methods through the one or more developers 610 or designers 615 may provide feedback on a product, service, experience, or the one or more projects allocated to them. These channels serve as communication pathways allowing the one or more developers 610 to express their opinions, report issues, and share their experiences. The user surveys are a valuable tool for gathering both quantitative and qualitative data, and they help organizations make informed decisions based on insights from the one or more developers 610. User surveys can take various forms, ranging from short questionnaires to more comprehensive research instruments. Further, iterative development is an approach to software development and project management where the development process is broken down into small, manageable cycles or iterations. Each iteration involves the planning, design, implementation, testing, and evaluation of a subset of the overall project's features or functionality. After each iteration, feedback is collected, and the next iteration is planned based on the insights gained. This process is repeated until the final product is complete.

The action determination module 685 further prioritizes the one or more actions based on a prioritization criteria. The one or more actions may be prioritized based on one or more factors. For instance, the one or more factors may include business value, customer impact, return on investment (ROI), cost of delay, and the like. The business value prioritizes tasks or features that deliver the most significant business value or contribute directly to organizational goals and objectives. The customer impact prioritizes items that enhance the experience of the one or more developers 610, address critical issues, or fulfill needs of the one or more developers 610. The ROI prioritizes tasks that offer the greatest financial or strategic benefits. The cost of delay prioritizes items where delay would have the most significant negative consequences. The one or more actions recommended to the one or more developers 610 are then presented in the order of priority.

In an exemplary embodiment, the rating module 690 generates a rating for each project based on the release feedback determined by the release feedback module 660. The rating may be presented to the one or more developers 610 using one or more scales, such as a star rating scale, numerical rating scale, graphical rating scale, descriptive rating scale, and the like. The rating may be useful for the one or more users 620 to determine which projects are performing well and which projects need improvement. The rating of each project may be presented using a dashboard.

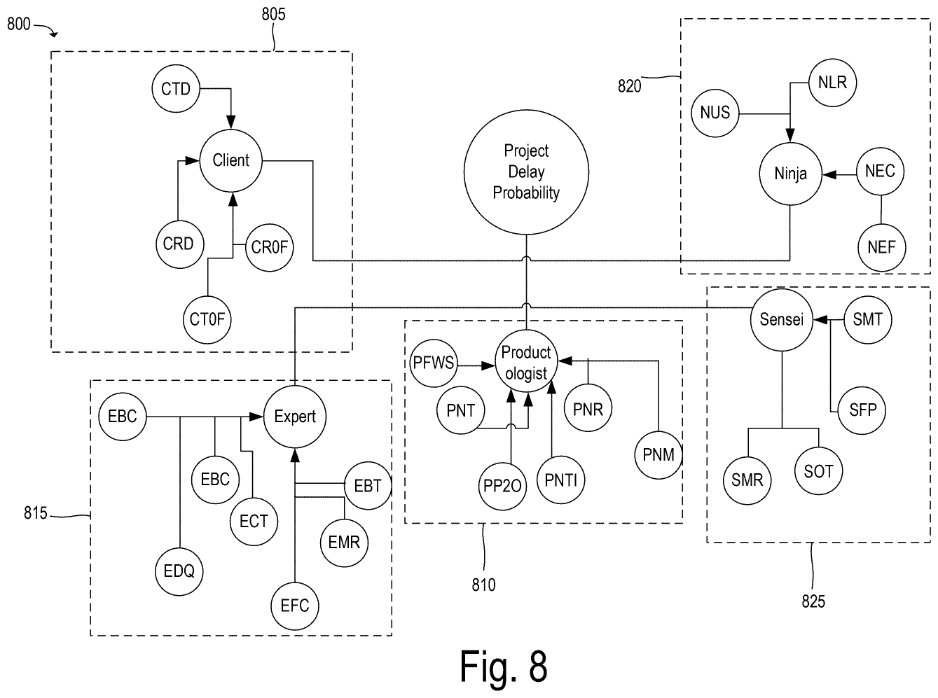

Referring to FIG. 8, FIG. 8 is a schematic illustrating a view 800 displaying a division of the one or more projects amongst one or more actors that contribute to each project in an embodiment of the disclosed subject matter. In an example, the one or more actors may include a client, productologist, expert, ninja, and sensei. As shown, the view 800 includes a first region 805 including to the client, a second region 810 corresponding to the productologist, a third region 815 including to the expert, a fourth region 820 corresponding to the ninja, and a fifth region 825 corresponding to the sensei. Each feature of the first region 805, the second region 810, the third region 815, the fourth region 820, and the fifth region 825 are explained in the below tables.

CLIENT

| | | |
|---|---|---|
| CTD | MedianClientResponseDelayHrDiscrete | Days taken by Client to respond to ToDo/Queries on |
| | | Builder 360. |
| CRD | MedianClientReleaseResponseDelayHr | Days taken by Client to respond to give |
| | Discrete | feedback for Builds/Releases |
| CT0F | NumOfTodosWithoutFeedback | Number of todos that have received no client feedback |
| | | at all |
| CR0F | NumOfReleasesWithoutFeedback | Number of releases (builds) that have not received |
| | | client comments |

PRODUCTOLOGIST

| | | |
|---|---|---|
| PP2O | DaysProject2OngoingDiscrete | Number of days taken to move project from New to |
| | | Ongoing state. |
| | | One of the CPE checklist item that tries to capture the |
| | | allocation efficiency. |
| PFWS | PhaseScorePropOfFeaturesWith | For every project, there should be at-least one epic with |
| | Stories Discrete | stories for every feature. This feature captures the CPE |
| | | work delegation efficiency. |
| PNM | NumMeetingsDiscrete | Average number of meetings per week with both |
| | | clients and developers Assuming all meetings are |
| | | captured in Builder 360. It is expected that for a |
| | | smooth running project there are atleast 2 meetings |
| | | per week. |
| PNT | NumOfTodosInProjectDiscrete | Number of Todos created by CPE |
| PNR | TotalReleasesDiscrete | Number of Releases created by CPE |
| PNTI | NumOfTodosFromPL | Total number of todos at the end of Roadmap and |
| | | Design phases. |

EXPERT

| | | |
|---|---|---|
| EBC | BuildcardComplexityScoreDiscrete | Captures the complexity of features in the build card. |
| EFC | FcsDiscrete | A measure of finished development work to date |
| | | considering the amount of project time elapsed. |
| EOB | PhaseTotalOpenBlockersDiscrete | Number of blockers on tracker. Blocked stories are one |
| | | of the major reasons of project delays primarily arising |
| | | due to lack of guidance/clarification from client or |
| | | change in circumstances of the assigned developer. |
| ECT | AvgCommitIntervalsHrs | Average time interval between git commits over all\ |
| | | experts |
| EMR | TimeSinceLastMergeRequest | Time since the last merge request in the project |
| EBS | AvgBratScores | Average BRAT scores for developers assigned to the |
| | | project |
| EBT | BugTaskRatio | A ratio between the bugs and task in the project stories |
| EDQ | DeallocationQualityIssues | Expert deallocation because of poor work quality or the |
| | | unavailability of the expert (reasons 2, 3) |

NINJA

| | | |
|---|---|---|
| NLR | DaysSinceLastRelease | Number of days that have passed since the last release |
| | | created |
| NEC | NumOfEstimateChanges | Total number of time estimate changes |
| NEF | EstimateIncreaseFactor | Average increase factor in time estimate per story |
| NUS | NumOfUnstartedStoriesFromPL | Number of unscheduled and unstarted stories at the |
| | | beginning of Full Build/MVP/Custom phases |

SENSEI

| | | |
|---|---|---|
| SMR | OpenMergeRequests | Number of open merge requests in all repositories |
| SOT | OpenTime | Average time of merge requests being open per |
| | | repository |
| SMT | MergeTime | Average time that it takes for the merge requests to be |
| | | merged per repository |
| SFP | NumberOfFailedPipelines | Number of ‘failed’ pipelines in all repositories |

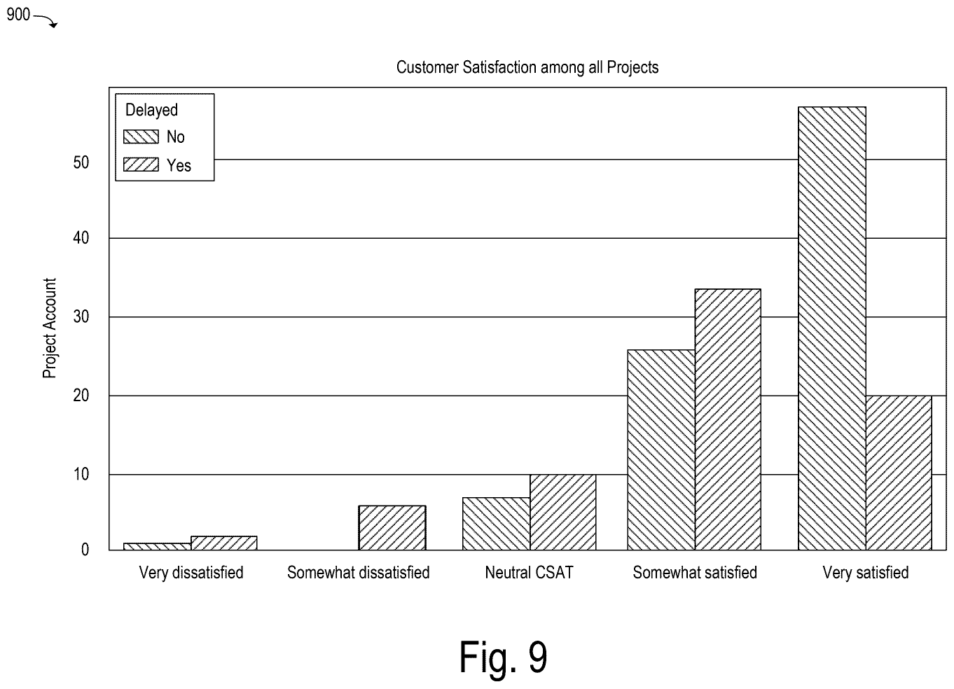

FIG. 9 is a schematic illustrating a view 900 displaying a bar graph depicting customer satisfaction for the one or more projects in an embodiment of the disclosed subject matter. A bar graph is a graphical representation of data where rectangular bars of equal width are drawn with lengths proportional to the values they represent. It's a common way to display categorical data, making it easy to compare different groups or categories. The y-axis of the bar graph is project account and the x axis of the bar graph is the customer satisfaction amongst all projects. The customer satisfaction mentioned may be very dissatisfied, somewhat dissatisfied, neutral CSAT, sometimes satisfied, and very satisfied.

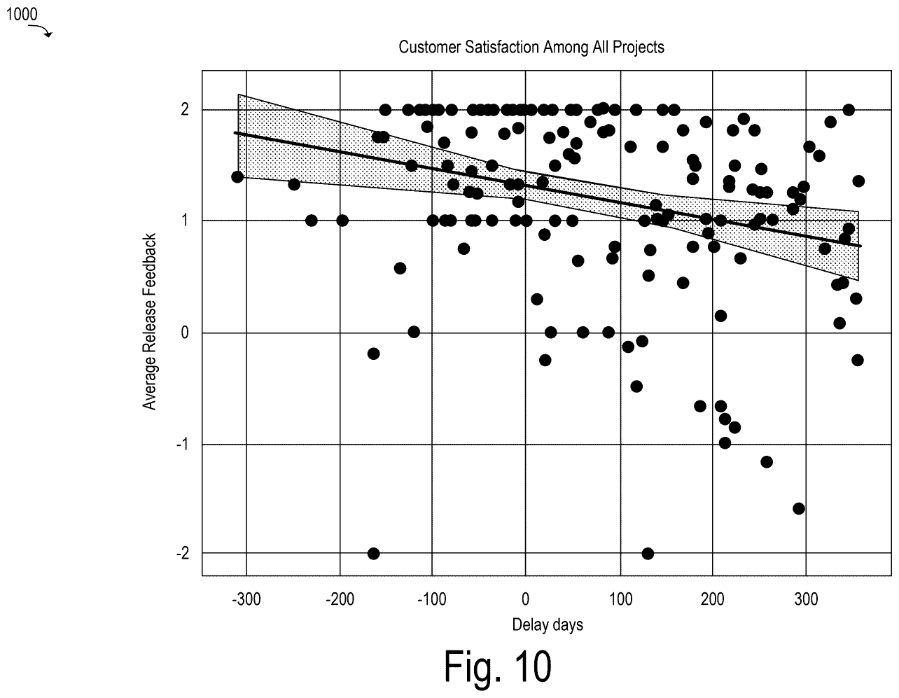

FIG. 10 is a schematic illustrating a view 1000 displaying a line graph depicting customer satisfaction for the one or more projects in an embodiment of the disclosed subject matter. A line graph is a type of chart that displays data points connected by straight line segments. It is useful for showing trends and changes in data over a continuous interval or time span. Line graphs are effective in illustrating the relationship between two variables and how one variable changes in response to the other. The y-axis of the line graph is average release feedback and the x-axis is delay days.

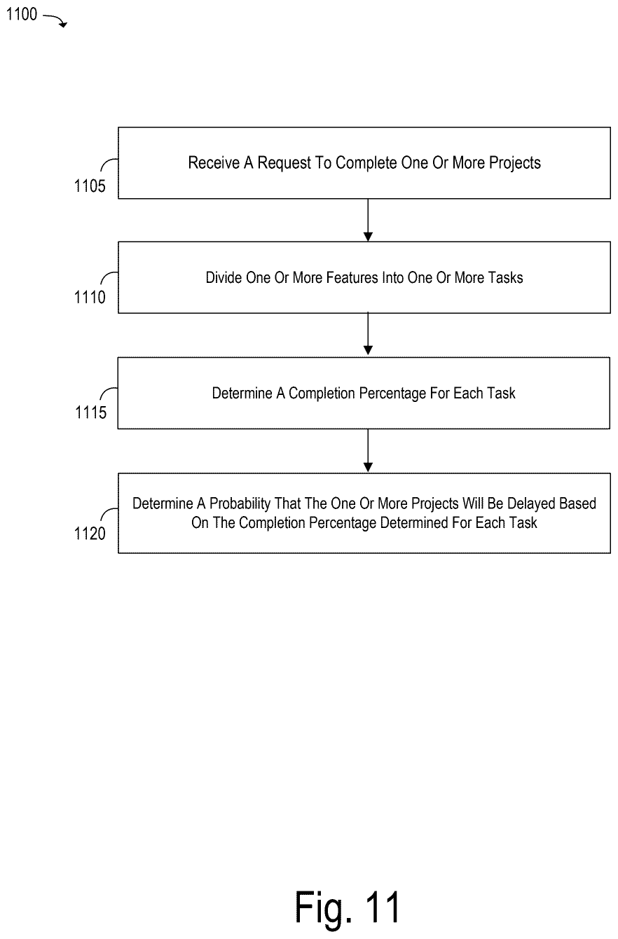

FIG. 11 is a flow diagram 1100 of an embodiment of the disclosed subject matter. The flow diagram 1100 illustrates a method for estimating a project delay. The software application may be any executable process on a computer system comprising instructions, designs, art, user interfaces, audio recordings, music, video, and the like. The software application is not limited to any commercial or consumer application. For example, the software application may be a utility application, a production application, a document generator, a game, and artistic application, and accounting application, or the like. Steps 1105-1120 of the flow diagram 1100 may be executed using the server 605 of FIGS. 6-7. Each step is explained in further detail below.

At step 1105, a request is received to complete one or more projects. The request may include one or more features assigned for each project, a project timeframe, and one or more building blocks that implement the one or more features. The one or more features may include a login screen, dashboard, login page, and the like. The users 620 may login via the login page by providing their email address, password, and other credentials useful for verifying their correct identity.

At step 1120, the one or more features of the request received in step 1105 are divided into one or more tasks. The one or more tasks include one or more actors that contribute to each project. In an example, the one or more actors may include a client, productologist, expert, ninja, and sensei. The client may refer to a person, a group/entity, or the one or more users 620 (as explained in FIG. 6) that initiate the one or more projects for completion. The one or more developers 610 and the one or more designers 615 communicate their work products to the client, who then reviews the same and provides their views/comments. Serving as the client's product owner, the productologist makes sure the client's vision is understood and that great customer service is provided. While the customer's product(s) are being developed, the productologist instructs, mentors, and provides guidance to the product manager. The productologist is in charge of advancing a build card to the appropriate stage so that it may be taken up for design or development after it has been completed.

The expert is in charge of creating different phases for one or more projects. For instance, one or more of the developers (610) and one or more of the designers (615) may be considered experts. The experts must meet specific requirements and be chosen according to predetermined standards in order to work on the projects. The experts might come from outside the company, from inside the company, or from other sources. In addition, the ninja is in charge of supervising the experts' work and employing them from a capacity network. The ninjas ensure that the experts release different iterations/stages of the projects on schedule. The customer is then informed of this tracking information by the ninjas. In addition, the sensei (may also be referred to as technical architect) delivers technical solutions while managing a large team.

At step 1125, a completion percentage for each task is determined. The percentage of completion is used to show how much weight each task has in relation to each project. One or more factors related to each actor may be used to calculate the completion rate. For example, the one or more factors may be dependent on the average amount of time needed to do each work, the complexity of the project, the project value, or anything similar.

The project complexity refers to a difficulty level of the projects. For instance, each project may be grouped into either an easy project, medium project, or tough project. This grouping may be provided by the users 620 for each project assigned by them to the developers 610 and the designers 615. The value of a project is correlated with the value that each project has for the stakeholders, clients, customers, and project managers, among others. Project cost, earned value, anticipated value, delays in the project, and similar elements can all be used to calculate the project value.

Based on the above-mentioned parameters, the percentages for each stage of the one or more projects are assigned. The proportion also shows how much weight each job has in relation to the project as a whole. Higher percentages may be allocated to the phases of a project if, for instance, the project has a high value, a medium-to-tough level of complexity, and an average time needed to accomplish each work. Less percentages may be allocated to the stages of projects with shorter average durations and lower levels of complexity.

At step 1120, a probability that the one or more projects will be delayed is determined based on the completion percentage determined in step 1115. In an example, the probability may be determined using a Bayesian network. A Bayesian network is a statistical model that depicts a set of variables and their probabilistic connections as a directed acyclic graph (DAG). It is also referred to as a Bayes network, belief network, or probabilistic directed acyclic graphical model (PDAG). In a Bayesian network, random variables are represented by nodes, while probabilistic relationships between the variables are represented by directed edges between nodes. A conditional probability distribution, which measures the likelihood of a variable adopting a certain value based on the values of its parent variables, is linked to each node.

The Bayesian network may be used to determine the likelihood of project delays after it has been built, started, and updated with data. One way to determine the condition or occurrence that indicates a project delay is to utilize a Bayesian network. This might be a particular activity taking longer than anticipated, a lack of resources, or any other element that causes delays in the project. Given the observed data, the posterior probability of the event of interest may also be questioned using the Bayesian network. The probability distribution of the occurrence given the project's present status must be calculated in order to accomplish this, and this may be done by applying the Bayes theorem. It is possible to assess the calculated probability to determine the possibility of project delays. This information may be presented as a probability distribution or a single probability value, depending on the specific goals of the analysis.

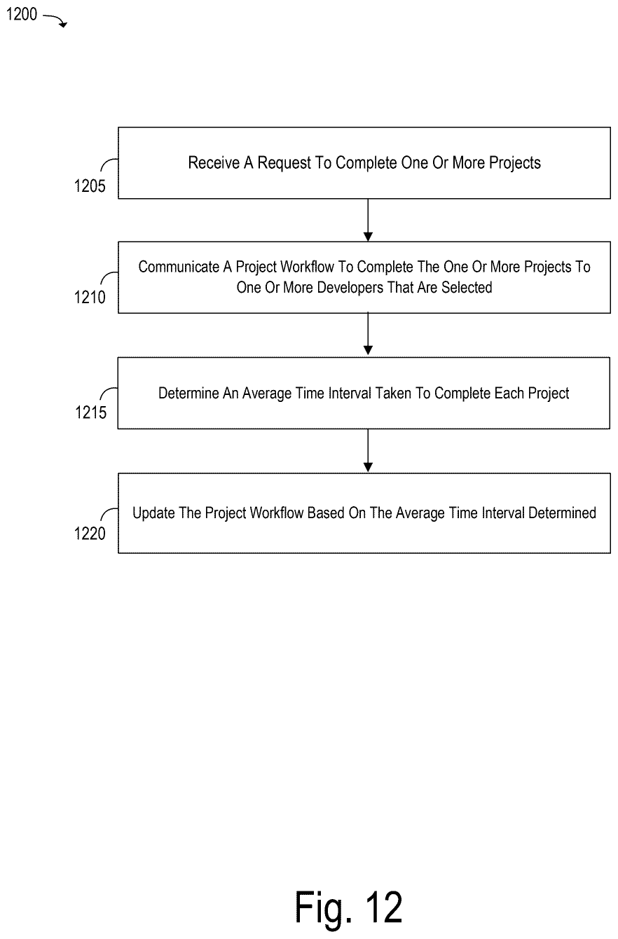

FIG. 12 is a flow diagram 1200 illustrating a method for managing one or more projects in an embodiment of the disclosed subject matter. Steps 1205-1220 of the flow diagram 1200 may be executed using the server 605 of FIGS. 6-7. Each step is explained in further detail below.

At step 1205, a request is received to complete one or more projects. The request may include one or more features assigned for each project, a project timeframe, and one or more building blocks that implement the one or more features. The one or more features may include a login screen, dashboard, login page, and the like. The users 620 may login via the login page by providing their email address, password, and other credentials useful for verifying their correct identity.

At step 1210, a project workflow to complete the one or more projects is generated. The generated project workflow is communicated to the one or more developers 610 that are selected to complete the one or more projects. The project workflow may be generated based on one or more parameters. The one or more parameters assist in timely completing each project. The one or more parameters may include at least one of a finish time path duration, a risk distribution, value of the project, a project speed, and a proximity to a completion deadline.

At step 1215, an average time interval taken to complete each project is determined. By aggregating the times needed for one or more of the 610 developers to do each work and dividing the total by the number of developers 610, the average time needed to accomplish each task is found. The time interval determination module 650 can track how long it takes one or more developers 610 to finish each task within the activity and then calculate the total amount of time needed to complete each task by adding up the task times, eliminating the need for the developers 610 to manually enter their times. The average time interval is also determined based on a combination of a previous time interval and a current time interval taken by the one or more developers 610 to complete each task of the one or more projects.

The previous time interval refers to previous times taken by the one or more developers 610 while working on the tasks and the current time interval refers to current or present times taken by the one or more developers 610 while working on the tasks. In order to determine the final/appropriate average time taken, the time interval determination module 650 compares the times of the one or more developers 610 from their past and present. The project workflow creation module 645 may then receive the average time interval(s) that were found by the time interval determination module 650. The previously developed project workflow may then be updated by the project workflow generating module 645. For instance, the modifications can involve changing the projects' duties, hiring extra developers 610 or designers 615 to work on activities that take longer to finish, setting new project deadlines, and so on.

At step 1220, the project workflow generated in step 1210 is updated based on the average time interval determined in step 1215.

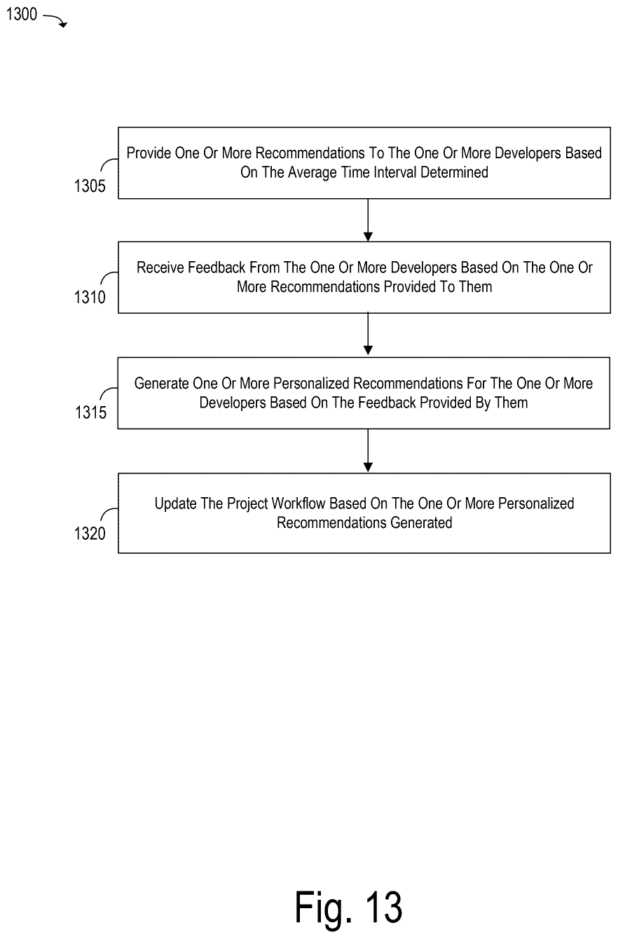

FIG. 13 is a flow diagram 1300 illustrating a method for providing recommendations to the one or more developers based on their average time interval in an embodiment of the disclosed subject matter. Steps 1305-1320 of the flow diagram 1300 may be executed using the server 605 of FIGS. 6-7. Each step is explained in further detail below.

At step 1305, one or more recommendations are provided to the one or more developers 610. The one or more recommendations may be provided based on the average time interval determined by the time interval determination module 650. The one or more developers 610 may benefit from the advice made in order to increase their productivity or output while working on the projects. One or more recommendations may be sent to the one or more developers 610 via voice, email, QR code, written message, or similar means at least in part. A written message is any communication that is expressed through written or printed language. This type of correspondence can be sent by text messages, emails, memoranda, reports, notes, memos, and more. Speech or sound is captured and delivered to a destination via voice message, a type of communication.

At step 1310, feedback is received from the one or more developers 610 based on the recommendations provided to them in step 1305. To have a deeper understanding is the primary goal of giving the feedback. The feedback gives the one or more developers 610 and the designers 615 a chance to voice any questions or concerns in a way that makes sense. Additionally, when working on one or more projects, the one or more developers 610 get live feedback via the live feedback module 680. The one or more developers 610 may provide their feedback using at least one of a voice message, verbal message, email message, QR code, and the like.

At step 1315, one or more personalized recommendations are provided to the one or more developers 610 based on the feedback received in step 1310. The personalized recommendations are provided to better the working progress of the one or more developers 610, as their thoughts are taken into consideration. The personalized recommendations may be updated in real-time as the preferences of the one or more developers 610 change or as new content becomes available.

At step 1320, the project workflow is updated based on the one or more personalized recommendations generated in step 1315.

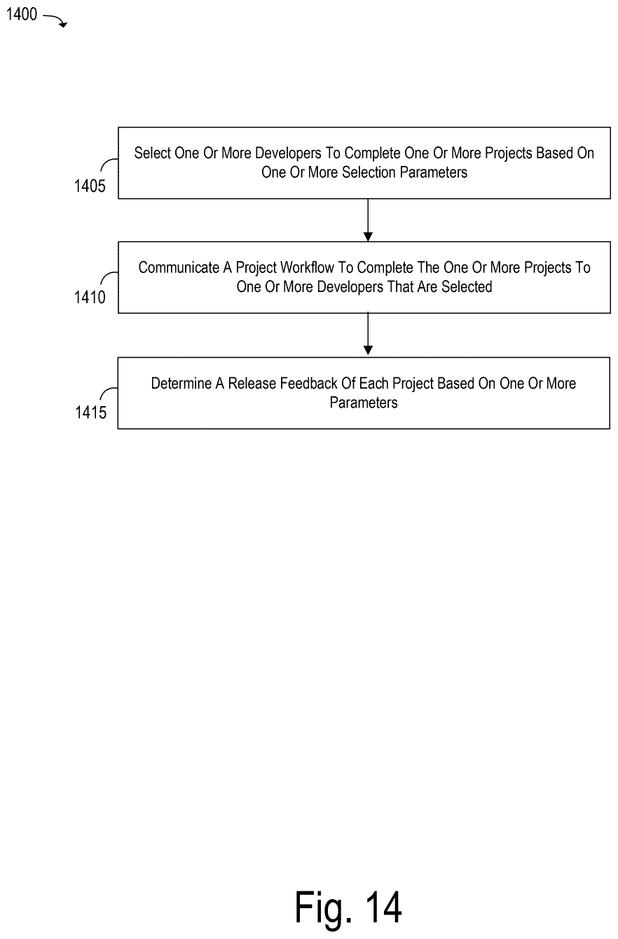

FIG. 14 is a flow diagram 1400 illustrating a method for evaluating one or more developers in an embodiment of the disclosed subject matter. Steps 1405-1415 of the flow diagram 1300 may be executed using the server 605 of FIGS. 6-7. Each step is explained in further detail below.

At step 1405, the one or more developers 610 are selected to complete the one or more projects. For instance, the one or more developers 610 may be selected based on one or more selection parameters. In an example, the one or more selection parameters may include a background of the one or more developers, works performed by the one or more developers, and a performance of the one or more developers in an onboarding assessment. For the one or more developers 610, the onboarding evaluation is an automated test that focuses mostly on programming languages like Java and C++. The developers 610 background and work history are examined by the selection module 655, which then creates a suitable quiz for them to complete. By doing this, you can be confident that the developers 610 are ready for their new position.

At step 1410, a project workflow to complete the one or more projects is communicated to the one or more developers 610 selected in step 1405. The project workflow refers to the sequence of steps or stages that a project follows from initiation to completion. It outlines the processes, tasks, and interactions necessary to achieve the project's objectives. The workflow provides a structured framework that helps in planning, executing, and monitoring the progress of a project.

At step 1415, a release feedback is determined for each project. The release feedback may be determined based on one or more parameters. For instance, the one or more parameters may be based on at least one of a customer satisfaction, bug reports, performance metrics, and project delay. Feedback or input received following the release of a product or program is referred to as release feedback. A firm or development team frequently asks users, customers, or other stakeholders for feedback before releasing a new feature, product, or version of software program. This helps them determine how well the release fulfills expectations and pinpoints any problems or areas that need to be improved.

Input on releases can take many different forms, including as bug reports, user reviews, consumer surveys, and direct user input via social media or support channels. The product teams need to analyze release comments in order to make well-informed decisions regarding next upgrades, features, and bug fixes. It aids in their comprehension of customer happiness, helps them spot unforeseen issues, and acquires information about the requirements and preferences of users.

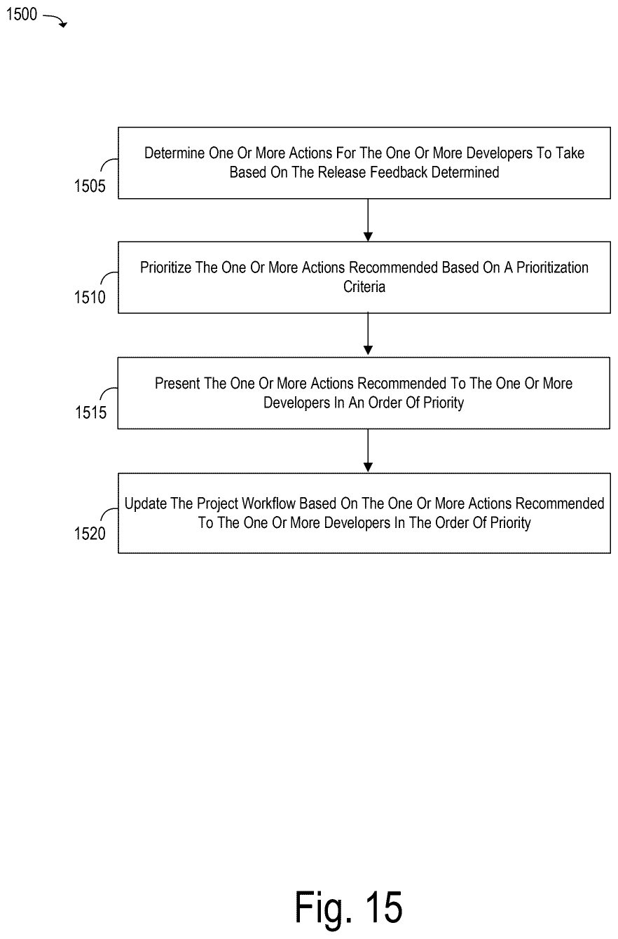

FIG. 15 is a flow diagram 1500 illustrating a method for determining actions for the one or more developers based on the release feedback in an embodiment of the disclosed subject matter. Steps 1505-1515 of the flow diagram 1500 may be executed using the server 605 of FIGS. 6-7. Each step is explained in further detail below.

At step 1505, one or more actions are determined for the one or more developers 610 to take based on the release feedback determined. Improving release feedback involves a combination of proactive planning, effective communication, and responsiveness to user input. For instance, the one or more actions may include beta testing, introducing feedback channels, user surveys, education, iterative development, and the like.

At step 1510, the one or more actions determined in step 1505 are prioritized based on a prioritization criteria. The one or more actions may be prioritized based on one or more factors. For instance, the one or more factors may include business value, customer impact, return on investment (ROI), cost of delay, and the like. Tasks or features that provide the most business value or directly support organizational goals and objectives are given priority according to their business value. Items that improve the one or more developers 610 experience, deal with important problems, or meet their wants are given priority in the customer impact. The tasks that have the most strategic or financial advantages are given priority by the ROI. Items where a delay would have the most detrimental effects are given priority based on the cost of delay.

At step 1515, the one or more actions recommended to the one or more developers 610 are presented in an order of priority. Such presentation enables the top recommendations or the recommendations having the highest value to be placed on top. This may thus help in grabbing the attention of the one or more developers 610 or designers 615 quickly.

At step 1520, the project workflow is updated based on the one or more actions recommended to the one or more developers in the order of priority.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and such modifications are considered to be within the scope of the present disclosure.

The embodiments herein and the various features and advantageous details thereof are explained with reference to the non-limiting embodiments in the following description. Descriptions of well-known components and processing techniques are omitted so as to not obscure the embodiments herein. The examples used herein are intended merely to facilitate an understanding of ways in which the embodiments herein may be practiced and to further enable those of skill in the art to practice the embodiments herein. Accordingly, the examples may not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications may and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any of these matters form a part of the prior art base or were common general knowledge in the field relevant to the disclosure as it existed anywhere before the priority date of this application.

The numerical values mentioned for the various physical parameters, dimensions or quantities are approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the embodiments, it will be appreciated that many embodiments can be made and that many changes can be made in the embodiments without departing from the principles of the disclosure. These and other changes in the embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for managing one or more projects, the system comprising:
a processor coupled to a memory, the processor configured to:
receive a request for completing one or more projects, wherein the request includes one or more features assigned for each project;
communicate to one or more developers that are selected by the processor, a project workflow to complete the one or more projects, wherein the project workflow is generated based on an optimization, by the processor, of one or more parameters for timely completing the projects;
determine an average time interval taken to complete each project; and
update the project workflow based on the average time interval determined.

2. The system of claim 1, wherein the request includes one or more building blocks that implement the one or more features, and wherein the one or more building blocks are reusable pieces of code that implement functionalities of the one or more features assigned for each project.

3. The system of claim 1, wherein the one or more parameters are based on at least one of an average time taken to complete each stage, a project complexity, and a value of the projects.

4. The system of claim 1, wherein the average time interval is determined based on a previous timeframe and a current timeframe.

5. The system of claim 1, wherein the processor is further configured to:
provide one or more recommendations to the one or more developers based on the average time interval determined;
receive feedback from the one or more developers based on the one or more recommendations provided to them; and
generate one or more personalized recommendations for the one or more developers based on the feedback provided by them.

6. The system of claim 5, wherein the processor is further configured to update the project workflow based on the one or more personalized recommendations generated.

7. A method for managing one or more projects, the method comprising:
receiving a request for completing one or more projects, wherein the request includes one or more features assigned for each project;
communicating to one or more developers that are selected, a project workflow to complete the one or more projects, wherein the project workflow is generated based on an optimization of one or more parameters for timely completing the projects;
determining an average time interval taken to complete each project; and
updating the project workflow based on the average time interval determined.

8. The method of claim 7, wherein the request includes one or more building blocks that implement the one or more features, and wherein the one or more building blocks are reusable pieces of code that implement functionalities of the one or more features assigned for each project.

9. The method of claim 7, wherein the one or more parameters are based on at least one of an average time taken to complete each stage, a project complexity, and a value of the projects.

10. The method of claim 7, wherein the average time interval is determined based on a previous timeframe and a current timeframe.

11. The method of claim 7, further comprising:
providing one or more recommendations to the one or more developers based on the average time interval determined;
receiving feedback from the one or more developers based on the one or more recommendations provided to them; and
generating one or more personalized recommendations for the one or more developers based on the feedback provided by them.

12. The method of claim 11, further comprising updating the project workflow based on the one or more personalized recommendations generated.

13. A computer readable storage medium having data stored therein representing software executable by a computer, the software comprising instructions that, when executed, cause the computer readable storage medium to perform:
receiving a request for completing one or more projects, wherein the request includes one or more features assigned for each project;
communicating to one or more developers that are selected by the processor, a project workflow to complete the one or more projects, wherein the project workflow is generated based on an optimization, by the processor, of one or more parameters for timely completing the projects;
determining an average time interval taken to complete each project; and
updating the project workflow based on the average time interval determined.

14. The computer readable storage medium of claim 13, wherein the request includes one or more building blocks that implement the one or more features, and wherein the one or more building blocks are reusable pieces of code that implement functionalities of the one or more features assigned for each project.

15. The computer readable storage medium of claim 13, wherein the one or more parameters are based on at least one of an average time taken to complete each stage, a project complexity, and a value of the projects.

16. The computer readable storage medium of claim 13, wherein the average time interval is determined based on a previous timeframe and a current timeframe.

17. The computer readable storage medium of claim 13, wherein the instructions further cause the computer readable storage medium to perform providing one or more recommendations to the one or more developers based on the average time interval determined.

18. The computer readable storage medium of claim 17, wherein the instructions further cause the computer readable storage medium to perform receiving feedback from the one or more developers based on the one or more recommendations provided to them.

19. The computer readable storage medium of claim 18, wherein the instructions further cause the computer readable storage medium to perform generating one or more personalized recommendations for the one or more developers based on the feedback provided by them.

20. The computer readable storage medium of claim 19, wherein the instructions further cause the computer readable storage medium to perform updating the project workflow based on the one or more personalized recommendations generated.
